(19) United States
(12) Patent Application Publication
(10) Pub. No.: US 2011/0292426 A1
(43) Pub. Date: Dec. 1, 2011

(54) COMMUNICATION APPARATUS AND COMMUNICATION METHOD

(75) Inventors: Jun Sasano, Kanagawa-ken (JP); Tomohide Oka, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/101,288

(22) Filed: May 5, 2011

Related U.S. Application Data
(60) Provisional application No. 61/350,254, filed on Jun. 1, 2010.
(60) Provisional application No. 61/350,254, filed on Jun. 1, 2010.

(30) Foreign Application Priority Data
Mar. 3, 2011 (JP) P2011-046399

(51) Int. Cl. G06F 3/12

(52) U.S. Cl. 358/1.13; 358/1.15

(57) ABSTRACT

A communication apparatus that stores at least one address of transmission destination, at least one file to be transmitted, and messages registered for each file that are received from an external device via an interface, and transmits the files and the messages registered for each file to a transmission destination terminal when receiving a transmission instruction of the files via the interface.

### CROSS-REFERENCE TO RELATED APPLICATION

The application is based upon and claims the benefit of priority from U.S. Provisional Application No. 61/350,254, filed Jun. 1, 2010; further this application is based upon and claims the benefit of priority from Japanese Patent Application No. P2011-046399, filed on Mar. 3, 2011; the entire contents of which are incorporated herein by references.

### FIELD

Embodiments of a present specification are generally related with a communication apparatus that performs communication via a network and a communication method thereof.

### BACKGROUND

There is a technique for transferring a file of media data such as voice, text, image, and video between IP communication apparatuses by using SIP. However, in such a transfer technique, on the receiving side, there is no information other than file name to know the content of the file until the received file is opened and the content of the file is checked.

### BRIEF DESCRIPTION OF THE DRAWINGS

FIG. 1 is a block diagram for explaining a configuration of a communication system.

FIG. 2 is a block diagram for explaining a hardware configuration of a communication apparatus according to an embodiment.

FIG. 3 is a block diagram for explaining a hardware configuration of a user terminal according to an embodiment.

FIG. 4 is a block diagram for explaining a hardware configuration of a multifunction apparatus according to the embodiment.

FIG. 5 is a flowchart for explaining a case in which the user terminal or the multifunction apparatus instructs the communication apparatus to transmit a file by using a Web browser function.

FIG. 6 is an example of a user interface screen in which file transmission is instructed from the user terminal by using a Web browser function.

FIG. 7 is a flowchart for explaining message transmission processing of the communication apparatus.

FIG. 8 is a sequence diagram showing communication processing from the start to the end of transmission of a first file.

FIG. 9 is a sequence diagram showing processing from the start to the end of transmission and communication of a second file.

FIG. 10 is a user interface screen which displays a list of file received by the communication apparatus and which is displayed on a display unit of an external device.

### DETAILED DESCRIPTION

An object of an embodiment described below to which the present invention is applied is to provide a communication apparatus and a communication method for improving user convenience by causing a receiving terminal to obtain information more than a received file name.

To achieve the above object, a communication apparatus according to the embodiment includes an interface for connecting an external device with a transmission destination terminal via a network, a memory for storing at least one address of transmission destination, at least one file to be transmitted, and messages registered for each file that are received from the external device via an interface, and a controller for transmitting the files and the messages registered for each file to the transmission destination terminal of the address via the interface when the controller obtains a transmission instruction of the files via the interface.

Hereinafter, embodiments of the present invention will be described with reference to the drawings.

### Embodiment

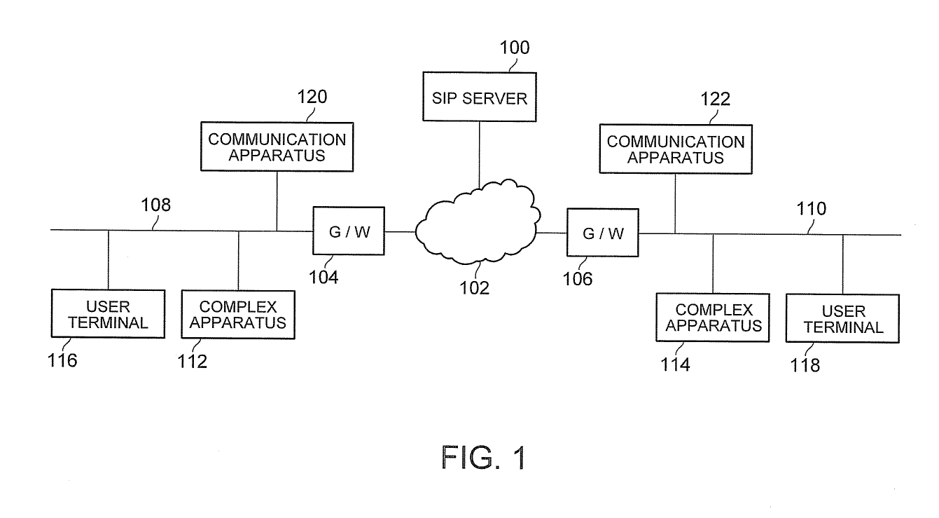

FIG. 1 is a block diagram for explaining an example of a configuration of a communication system. The communication system includes a SIP (Session Initiation Protocol) server 100, a network 102, G/Ws (Gateways) 104 and 106, communication apparatuses 120 and 122, multifunction apparatuses 112 and 114, and user terminals 116 and 118. The communication apparatus 120, the multifunction apparatus 112, and the user terminal 116 are connected to the network 102 via a LAN 108 and the G/W 104. The communication apparatus 122, the multifunction apparatus 114, and the user terminal 118 are connected to the network 102 via the LAN 110 and the G/W 106. The SIP server 100 communicates with the communication apparatuses 120 and 122 via the network 102. Although the system shown in FIG. 1 includes two communication apparatuses, two multifunction apparatuses, and two user terminals connected to the network 102, the numbers of the communication apparatuses, the multifunction apparatuses, and the user terminals may be three or more. The communication apparatus is connected to at least one of the multifunction apparatus and the user terminal. The network 102 may be NGN (Next Generation Network) which is a dedicated network for telecommunications carriers, or may be the publicly known Internet. In the description of FIG. 1, the network 102 is assumed to be NGN as an example.

The G/Ws 104, 106 adjust various differences between the LANs 108, 110 and the network 102. The G/Ws 104 and 106 enable devices connected to the LANs 108 and 110 to perform communication via the network 102. The G/Ws 104 and 106 may include a port to which an analog communication terminal is connected. In this case, the G/Ws 104 and 106 enable the analog communication terminal to perform communication via the network 102.

The communication apparatuses 120 and 122 establish a session by transmitting and receiving a SIP message to and from each other via the SIP server 100 in call control processing, and transfer media data (voice, text, image, video, and the like) (hereinafter referred to as “file transfer”) in communication processing thereafter. For example, the communication apparatus 120 transmits media data from the multifunction apparatus 112 and the user terminal 116 to the communication apparatus 122 via the network 102. The communication apparatus 122 has the same function as that of the communication apparatus 120.

The SIP server 100 relays a SIP message for a call connection between the communication apparatuses 120 and 122. The SIP server 100 manages information such as the global address, the port number, the type of NAT (Network Address Translation) of the communication apparatuses 120 and 122 (the SIP server 100 performs registration, update, and deletion of information in the location server).

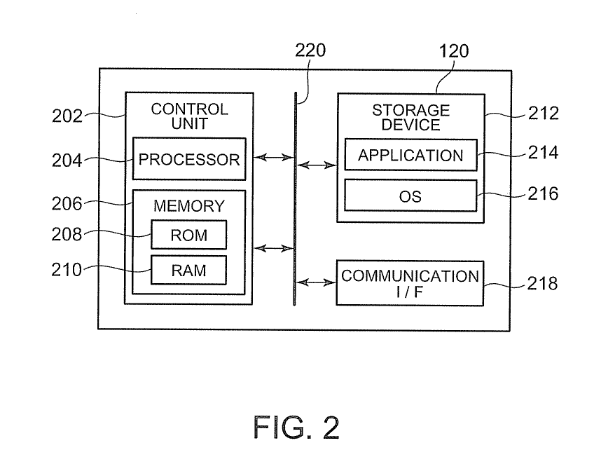

FIG. 2 is a block diagram for explaining a hardware configuration of the communication apparatuses 120 and 122 according to the embodiment. Here, the communication apparatus 120 will be described as an example.

The communication apparatus 120 includes software and hardware for performing communication with devices on the LAN 108, the SIP server 100, and the communication apparatus 122, or an appropriate combination of these.

The communication apparatus 120 includes a control unit 202, a storage device 212, and a communication interface (communication I/F) 218.

The control unit (controller) 202 has a processor 204 including a CPU (Central Processing Unit) or a MPU (Micro Processing Unit) and a memory 206. The control unit 202 processes a document including graphics, images, characters, tables, and the like. The control unit 202 controls processing of file transfer with the other side communication apparatus. The memory 206 is, for example, a semiconductor memory, and includes a ROM (Read Only Memory) 208 for storing various control programs and a RAM (Random Access Memory) 210 for providing a temporary work area to the processor 204. The components in the communication apparatus 120 are connected to each other via a bus 220.

The storage device 212 stores an application program 214 and an OS 216 which is a program causing the processor 204 to function. The application program 214 works as software of the OS 216. The application program 214 includes a Web application program in addition to general software. The application program 214 includes a program for forming a screen displayed on the multifunction apparatus 112 or the user terminal 116 on the LAN 108. The storage device 212 stores media data (voice data, text data, image data, video data, and the like) obtained via the communication I/F 218. The storage device 212 stores, for example, media data transmitted from the communication apparatus 122 and media data received from the multifunction apparatus 112 or the user terminal 116 on the LAN 108. The storage device 212 may be, for example, a hard disk drive or another magnetic storage device, an optical storage device, a semiconductor storage device such as a flash memory, or an arbitrary combination of these. The communication apparatus 120 may use a server, a PC, or another storage device connected via the communication I/F 218 instead of the storage device 212.

The communication I/F 218 is an interface for connecting with external devices. The communication I/F 218 includes an appropriate wireless or wired interface compliant with IEEE 802.15, IEEE 802.11, IEEE 802.3, IEEE 1284, or the like including, for example, Bluetooth (registered trademark), infrared connection, and optical connection. The communication I/F 218 may further include a USB connection portion to which a USB standard connection terminal is connected, a parallel interface, and the like. The communication I/F 218 transmits and receives media data to and from an external device. The control unit 202 communicates with the G/W 108, the SIP server 100, the other side device (for example, the communication apparatus 122), and other external devices via the communication I/F 218 in accordance with a predetermined communication protocol.

The control unit 202 functions by the control program in the ROM 208 and the OS 216. For example, the control unit 202 exchanges SIP messages with SIP server 100 and the other side device, and establishes a session.

The control unit 202 generates a transmission file from media data received from the multifunction apparatus 112 or the user terminal 116. Data from the multifunction apparatus 112 includes image data obtained by scanning an original document by the multifunction apparatus. When the scanned data has a plurality of pages, the control unit 202 receives media data from the multifunction apparatus 112 as a single file. Or, on the basis of a read condition of the multifunction apparatus 112, the control unit 202 may receive the media data as a plurality of files on a page by page basis.

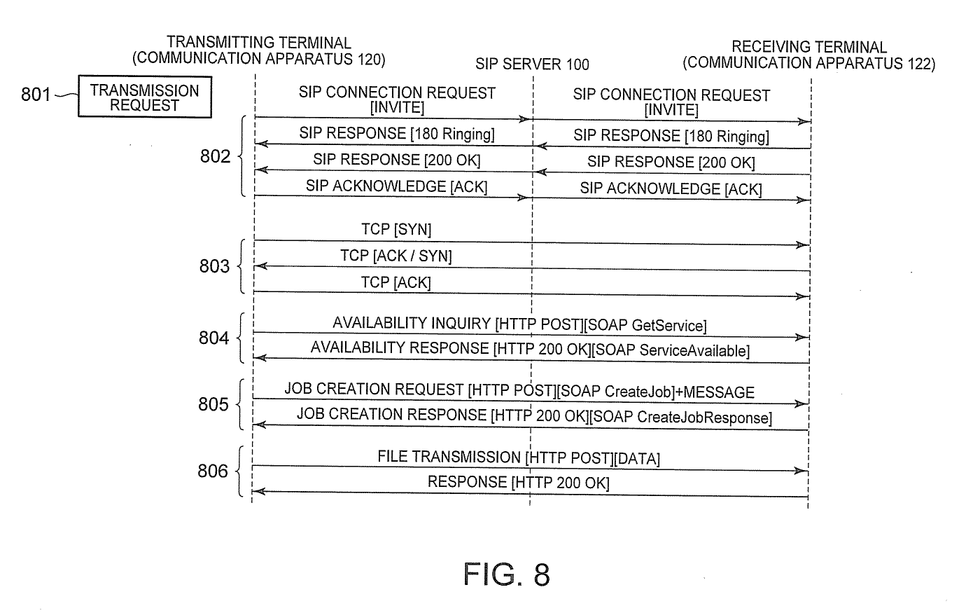

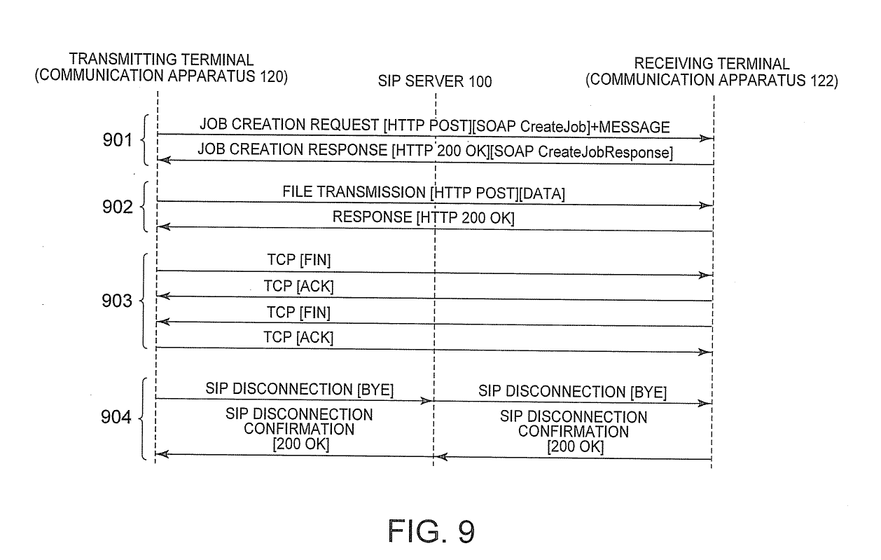

Subsequently, the control unit 202 performs processing for packetizing and transmitting the media data generated as a file. The control unit 202 checks for arrival of data, overlapping of data, missing of data, and the like on the basis of TCP (Transmission Control Protocol). The control unit 202 uses, for example, a protocol defined by RFC3261. As described below in FIGS. 8 and 9, for example, the control unit 202 exchanges availability information related to a file transfer function and information of the file to be transferred (for example, a file name, a file format, and a file size) with the other side device by using a SDP (Session Description Protocol) document on the SIP message.

The control unit 202 stores a file received from the other side device into the storage device 212. When the control unit 202 receives an instruction for performing printing from the other side device, the control unit 202 transfers the file to a predetermined image forming device. The image forming device (for example, the multifunction apparatus 112) that receives the transferred file generates image data for printing and prints the image data on a sheet.

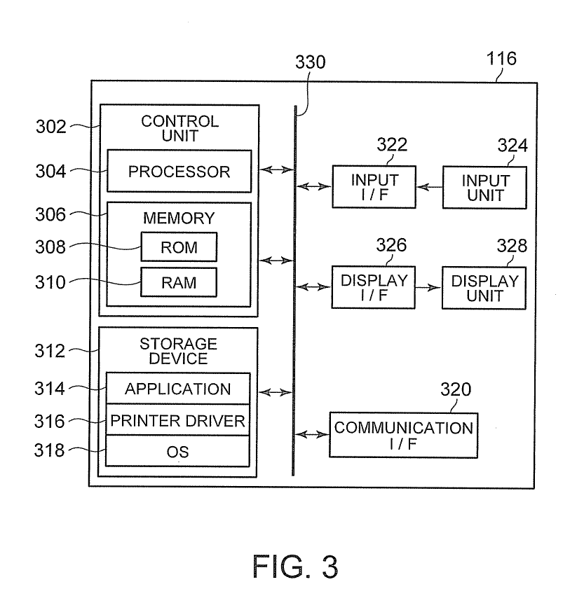

FIG. 3 is a block diagram for explaining a hardware configuration of the user terminal 116 and 118 according to the embodiment. Examples of the user terminals 116 and 118 include a desktop PC (Personal Computer), a laptop PC, a tablet PC, a mobile phone, a PDA (Personal Digital Assistant), and a media player. Here, the user terminal 116 will be described by using a PC as an example.

The user terminal (PC) 116 includes software and hardware for performing communication with the communication apparatus 120 and the multifunction apparatus 112 or an appropriate combination of these. The user terminal 116 also includes a Web browser for communicating with various web pages and device pages or an appropriate interface to other special applications.

The user terminal (PC) 116 includes a control unit 302, a storage device 312, a communication interface (communication I/F) 320, an input interface (input I/F) 322, an input unit 324, a display interface (display I/F) 326, and a display unit 328.

The control unit (controller) 302 has a processor 304 including a CPU (Central Processing Unit) or a MPU (Micro Processing Unit) and a memory 306. The control unit 302 processes a document including graphics, images, characters, tables, and the like. The memory 306 is, for example, a semiconductor memory, and includes a ROM (Read Only Memory) 308 for storing various control programs and a RAM (Random Access Memory) 310 for providing a temporary work area to the processor 304. The components in the user terminal (PC) 116 are connected to each other via a bus 330.

The storage device 312 stores an application program 314, a printer driver 316, and an OS 318 which is a program causing the processor 304 to function. The application program 314 works as software of the OS 318. The application program 314 includes a Web browser, a Web application program in addition to general software. The printer driver 316 is a device driver for controlling the multifunction apparatus 112 in accordance with a print instruction from the application program 314, and works as software of the OS 318. The storage device 312 may be, for example, a hard disk drive or another magnetic storage device, an optical storage device, a semiconductor storage device such as a flash memory, or an arbitrary combination of these.

The communication I/F 320 is an interface for connecting with external devices. The communication I/F 320 communicates with the multifunction apparatus 112 via an appropriate wireless or wired interface compliant with IEEE 802.15, IEEE 802.11, IEEE 802.3, IEEE 3304, or the like including, for example, Bluetooth (registered trademark), infrared connection, and optical connection. The communication I/F 320 may further include a USB connection portion to which a USB standard connection terminal is connected, a parallel interface, and the like. The control unit 302 communicates with the multifunction apparatus 112, a USB device, and the other external devices via the communication I/F 320.

The input I/F 322 is connected to the input unit 324. For the input unit 324, a keyboard device and a mouse are used as a man-machine interface.

The display I/F 326 is connected to the display unit 328. The display I/F 326 receives data or an instruction to be displayed on the display unit 328 from the other components connected to the bus 330. The display I/F 326 outputs display data to the display unit 328. As the display unit 328, for example, a display attached to the PC is used.

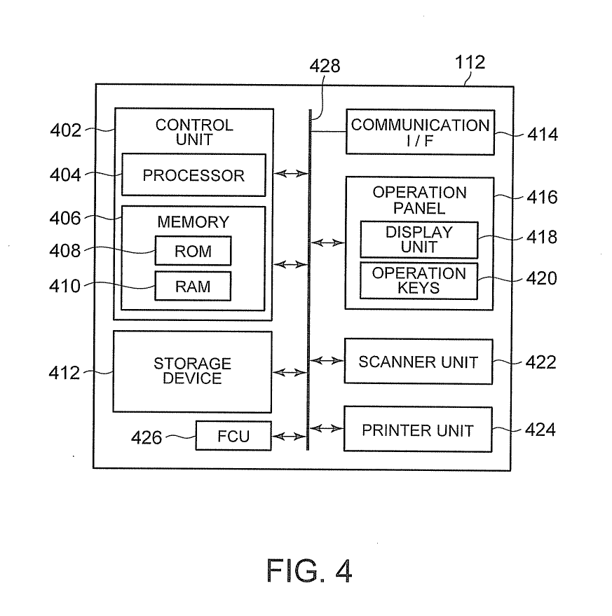

FIG. 4 is a block diagram for explaining a hardware configuration of the multifunction apparatuses 112 and 114 according to the embodiment. Here, the multifunction apparatus 112 will be described as an example.

The multifunction apparatus 112 includes a control unit 402, a storage device 412, a communication interface (communication I/F) 414, an operation panel 416, a scanner unit 422 for reading an original document, a printer unit 424 for forming an image, and a facsimile control unit (FCU) 426. The components in the multifunction apparatus 112 are connected to each other via a bus 428.

The control unit 402 has a processor 404 including a CPU (Central Processing Unit) or a MPU (Micro Processing Unit) and a memory 406. The memory 406 is, for example, a semiconductor memory, and includes a ROM (Read Only Memory) 408 for storing a control program and the like and a RAM (Random Access Memory) 410 for providing a temporary work area to the processor 404. The control unit 402 controls the operation panel 416, the scanner unit 422, the printer unit 424, and the facsimile control unit (FCU) 426 on the basis of various programs and the like stored in the ROM 408 or the storage device 412. The control unit 402 further includes a function for correcting or decompressing image data.

The storage device 412 stores an application program and an OS. The application program includes programs for executing functions included in the multifunction apparatus, such as a copy function, a print function, a scanner function, a facsimile function, and a network file function. The application program further includes an application (Web browser) for a Web client and other applications.

The storage device 412 temporarily stores image data of an original document read by the scanner unit 422 or image data obtained via the communication I/F 414. Further, the storage device 412 appropriately stores software update information, protected electronic document, text data, account information, policy information, and the like. The storage device 412 may be, for example, a magnetic storage device such as a hard disk drive, an optical storage device, a semiconductor storage device (flash memory or the like), or an arbitrary combination of these storage devices.

The communication I/F 414 is an interface for connecting with external devices. The communication I/F 414 communicates with external devices via an appropriate wireless or wired interface compliant with IEEE 802.15, IEEE 802.11, IEEE 802.3, IEEE 1284, or the like including, for example, Bluetooth (registered trademark), infrared connection, and optical connection. The communication I/F 414 may further include a USB connection portion to which a USB standard connection terminal is connected, a parallel interface, and the like. The control unit 402 communicates with the communication apparatus 120, the user terminal 116, a USB device, and other external devices via the communication I/F 414.

The operation panel 416 includes a touch panel type display unit 418 and various operation keys 420. The operation keys 420 include, for example, a numeric keypad, a reset key, a stop key, a start key, and the like. The display unit 418 displays instruction items related to a printing condition such as, for example, a paper size, the number of copies, a print density setting, a finishing (binding, folding), and the like. The display unit 418 also displays instruction items related to a file transmission condition such as a destination address for transmitting a facsimile or transmitting a file, a read setting of a file to be transmitted, a processing setting that specifies how the transmission destination processes the transmitted file, and the like. Instructions of the displayed items are inputted from the display unit 418.

The scanner unit includes a built-in scanning read unit for reading an original document as an image, an original document placement table, and an automatic original document feeder for transporting an original document to a reading position. The scanning read unit of the scanner unit 422 reads an original document set on the original document placement table or the automatic original document feeder.

The printer unit 424 includes, for example, an image forming unit including a photosensitive drum and a development unit using toner, which are publicly known. The printer unit 424 forms an image corresponding to image data of an original document read by the scanner unit 422 and an image corresponding to image data transmitted from the user terminal 116 on a sheet by these units. The printer unit 424 also prints a file obtained from the communication apparatus 120 via the communication I/F 414 on a sheet.

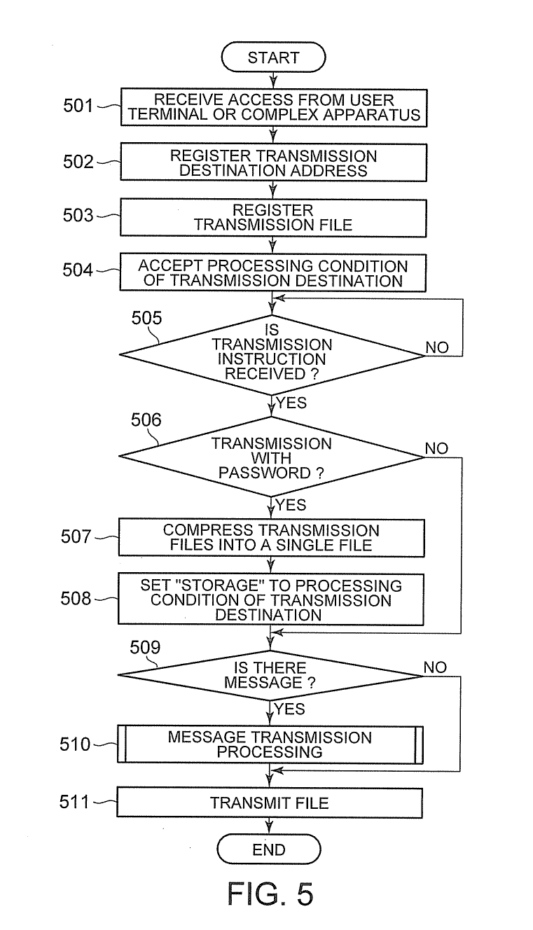

Next, a case in which file transmission is instructed from the user terminal 116 or the multifunction apparatus 112 will be described. FIG. 5 is a flowchart for explaining a case in which the user terminal 116 or the multifunction apparatus 112 instructs the communication apparatus 120 to transmit a file by using a Web browser function.

In 501 in FIG. 5, the user terminal 116 or the multifunction apparatus 112 accesses the communication apparatus 120 by using the Web browser function. In 502, the communication apparatus 120 accepts a registration of an address of the transmission destination via a user interface of the user terminal 116 or the multifunction apparatus 112. The user directly inputs the address of the transmission destination or registers the destination address by selecting the destination address from the address book or the transmission/reception history stored in the communication apparatus 120. The address book used to select the destination address is not limited to the address book stored in the communication apparatus 120, and the destination address may be selected from an address book stored in the user terminal 116 or the multifunction apparatus 112. A plurality of destination addresses may be registered at the same time. In the embodiment, as an example, a telephone number XXXXXXXXXX of the communication apparatus 122 is registered as a destination address.

In 503, the communication apparatus 120 accepts a registration of a file to be transmitted. For example, on the basis of a user instruction, a directory is specified in which a file transmitted from the user terminal 116, the multifunction apparatus 112, or the server is stored. Subsequently, when the communication apparatus 120 receives an instruction for determining the transmission file from the user terminal 116 or the multifunction apparatus 112, the communication apparatus 120 receives the transmission file from the user terminal 116 or the multifunction apparatus 112 and stores the transmission file into the storage device 212.

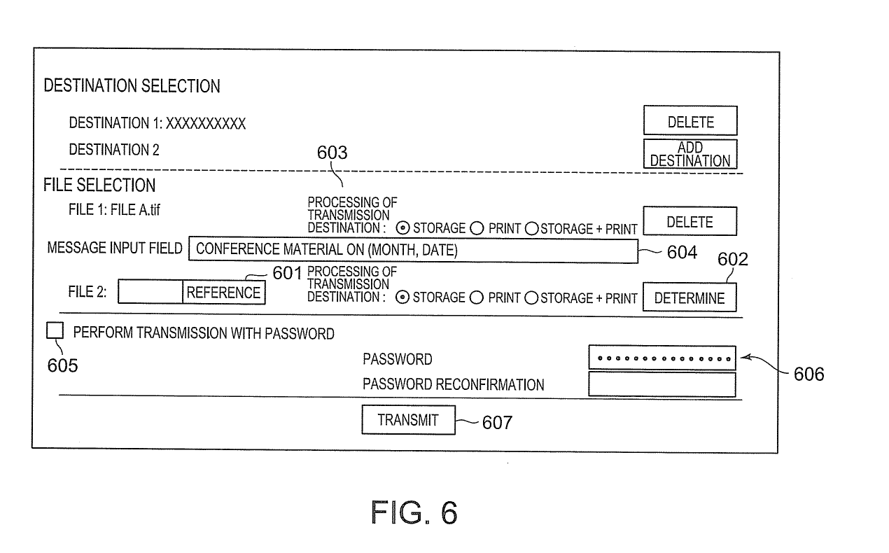

FIG. 6 is an example of a user interface screen in which file transmission is instructed from the user terminal 116 by using a Web browser function. By selecting a “reference” button 601 to select the transmission file, the directory in which the file to be transmitted is stored is specified. Subsequently, by selecting a “determination” button 602, the specified file is transmitted from the user terminal 116 or the multifunction apparatus 112 to the communication apparatus 120, and the file is stored into the storage device 212 of the communication apparatus 120.

The communication apparatus 120 receives image data of an original document scanned by the scanner unit 422 of the multifunction apparatus 112, and stores the image data into the storage device 212 as a transmission file. In other words, the multifunction apparatus 112 scans an original document by using the scanner unit 422 and transfers image data of the scanned original document to the communication apparatus 120.

In 504, the communication apparatus 120 accepts a processing condition indicating how the file to be transmitted is processed in the transmission destination via the user interface of the user terminal 116 or the multifunction apparatus 112. As shown in FIG. 6, for example, the processing condition 603 of the transmission destination includes “storage”, “print”, and “storage +print”. The processing condition 603 set here and the transmission file are transmitted to the destination which is the communication apparatus 122. The communication apparatus 122 which receives the transmission file and the processing condition 603 processes the received file on the basis of the processing condition 603. In this embodiment, the processing condition 603 is set for each transmission file.

When “storage” is selected as the processing condition 603, the destination communication apparatus 122 stores the received file into the storage device of the communication apparatus 122. When “print” is selected as the processing condition 603, the destination communication apparatus 122 transfers the received file to the image forming device (for example, multifunction apparatus 114) which is registered as a device for performing printing in advance. The multifunction apparatus 114 prints the received file. If the printing cannot be performed by the multifunction apparatus 114 (because of power-off of the multifunction apparatus or a network error) even when “print” is set, the communication apparatus 122 stores the received file into the storage device of the communication apparatus 122. When “storage +print” is selected as the processing condition 603, the destination communication apparatus 122 transfers the received file to the image forming device (for example, multifunction apparatus 114) which is registered as a device for performing printing in advance.

Reference numeral 604 in FIG. 6 denotes an input field (hereinafter referred to as a comment input field) in which a character string such as a comment (hereinafter referred to as a character string such as a comment or simply referred to as a message) is inputted. The message inputted in the comment input field 604 is obtained by the communication apparatus 120 and transmitted to the communication apparatus 122 which is the transmission destination when the file is transmitted. In the embodiment, the message can be registered for each file.

Reference numeral 605 in FIG. 6 denotes a check box for setting enable/disable of “transmission with password”. When the check box 605 is checked and “transmission with password” is enabled, the input field 606 is enabled and a password can be accepted. Reference numeral 606 in FIG. 6 denotes an icon for instructing the communication apparatus 120 to perform file transmission processing.

In 505, the control unit 202 of the communication apparatus 120 determines whether the transmission instruction is received. When the transmission instruction is received (Yes in 505), in 506, the control unit 202 of the communication apparatus 120 determines whether the setting of “transmission with password” is enabled.

When the setting of “transmission with password” is disabled (No in 506), in 509, the control unit 202 of the communication apparatus 120 determines whether there is a message which is a character string of comment associated with each transmission file. If there is no message associated with each transmission file (No in 509), the control unit 202 of the communication apparatus 120 transmits the transmission file and the processing condition 603 to the communication apparatus 122 via the communication I/F 218 (511).

When the setting of “transmission with password” is enabled (Yes in 506), the control unit 202 of the communication apparatus 120 compresses the files to be transmitted into a single file in a predetermined format with the password inputted into the input field 605 (507). The control unit 202 of the communication apparatus 120 creates a file name of the compressed file by adding an extension of the compression method to the file name of the first file (the file registered earliest) in the list of the files to be transmitted.

Subsequently, in 508, the control unit 202 of the communication apparatus 120 sets “storage” to the processing condition 603 of the transmission destination regardless of the processing condition 603 of the transmission destination set in 504. Therefore, when the check box 604 is checked and “transmission with password” is enabled, the destination communication apparatus 122 automatically stores the received file into the storage device regardless of the setting of the processing condition 603.

In 509, if it is determined that there are messages associated with each transmission file (Yes in 509), the control unit 202 of the communication apparatus 120 performs message transmission processing in 510.

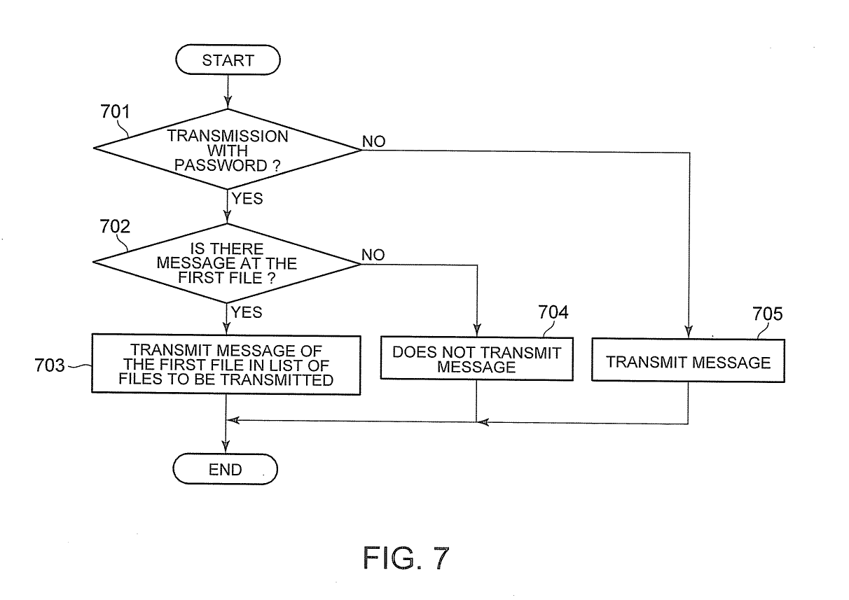

FIG. 7 is a flowchart for explaining the message transmission processing performed by the control unit 202 of the communication apparatus 120 in 510 in FIG. 5. In 701, the control unit 202 determines whether the transmission processing is transmission with password. If the transmission processing is not the transmission with password (No in 701), the control unit 202 transmits messages that are character strings such as a comment associated with each file to the destination communication apparatus 122 (705).

On the other hand, the transmission processing is the transmission with password (Yes in 701), the control unit 202 determines whether there is a message associated with the first file (the file registered earliest) in the list of the files compressed in 507 in FIG. 5 (702). If there is no message associated with the file registered earliest (No in 702), the control unit 202 does not transmit a message regardless of the presence or absence of messages associated with other files (704).

If there is a message associated with the file registered earliest (Yes in 702), in 703, the control unit 202 transmits only the message associated with the file registered earliest to the destination communication apparatus 122. In addition, in the above mentioned example, the file name of the compressed file is the file name adding an extension of a compression method to the file name of the top front of a file list (earliest registered file) to be transmitted. It does not apply only the top front file of the list, it may be second or later one of the list or the last one of the list. Further, to input arbitrarily the file name by a user, a screen which urges to input a file name may be displayed and a user may input the file name. Additionally, a user may select a top front one, a second one or last one among a file name list.

FIGS. 8 and 9 are sequence diagrams showing communication processing in the communication system of FIG. 1. FIG. 8 shows transmission processing of a first file until the transmission is completed. FIG. 9 shows transmission processing of a second file and processing until the communication is finished after the second file has been transmitted. FIGS. 8 and 9 show a series of processing. The communication apparatus 120 (hereinafter referred to as a transmitting terminal) which operates as a transmitting terminal and the communication apparatus 122 (hereinafter referred to as a receiving terminal) which operates as a receiving terminal perform registration processing (transmission of a REGISTER command or the like) to the SIP server 100 in advance.

As shown in FIG. 8, in 801, the transmitting terminal dials the destination number of the receiving terminal to send a call request (transmission request).

In 802, the transmitting terminal transmits an INVITE command for starting a session, and exchanges a series of SIP commands with the receiving terminal via the SIP server 100. Subsequently, the called party is called from the SIP server, and a 180 Ringing command which indicates that the called party is being called is transmitted to the transmitting terminal via the SIP server. Next, when the transmitting terminal receives a 200 OK command via the SIP server, the transmitting terminal recognizes that the communication is established, and transmits an ACK command to the SIP server as a response command. In this way, a SIP call connection is completed.

In 803, the transmitting terminal and the receiving terminal establish a connection. Establishing a connection means that a logical communication path (connection) for performing communication is set between the transmitting terminal and the receiving terminal. The transmitting terminal sends a SYN command in which a port number of the receiving terminal to be connected and a sequence number of the transmitting terminal are specified to try to establish an upstream connection. The receiving terminal tries to establish a downstream connection by responding to the SYN command from the transmitting terminal with an ACK command that acknowledges the establishment of the upstream connection and sending a SYN command in which a sequence number of the receiving terminal is specified. The transmitting terminal responds to the SYN command from the receiving terminal with an ACK command that acknowledges the establishment of the downstream connection. Here, for convenience, the transfer direction from the transmitting terminal to the receiving terminal is referred to as upstream, and the opposite transfer direction is referred to as downstream. Based on the above processing, the connection is established before transferring data such as a file.

In 804, the transmitting terminal transmits a SOAP Get Service command for inquiring availability and exchanges a series of SOAP commands with the receiving terminal. When the transmitting terminal receives a SOAP Service Available command which is an availability response, the transmitting terminal obtains an availability file of the receiving terminal. When the receiving terminal receives a SOAP Get Service command, the receiving terminal obtains an availability file of the transmitting terminal.

In 805, the transmitting terminal requests the receiving terminal to allow the start of a job by a SOAP Create Job command (job creation request). The SOAP Create Job command includes attributes necessary for starting a job, such as, for example, a user name, a job name, a file name, a format of transmission file (for example, tiff or the like), the size of the first file to be transmitted, and the processing condition 603 associated with the first file. In the embodiment, when there is a message that is a character string such as a comment associated with the transmission file described in FIGS. 5 and 6, the transmitting terminal transmits the message to the receiving terminal along with the SOAP Create Job command.

When the receiving terminal receives the SOAP Create Job command, the receiving terminal recognizes the attribute of the first file transmitted from the transmitting terminal. The receiving terminal checks the size of the first transmission file included in the SOAP Create Job command and the capacity of the memory or the storage device of the receiving terminal, and when the free space is sufficient, the receiving terminal transmits a SOAP Create Job Response command that allows the start of the job to the transmitting terminal (job creation response).

When the transmitting terminal receives the SOAP Create Job Response command, the transmitting terminal recognizes that the job creation request is allowed. When a session is established by the above communication, in 806, the transmitting terminal transmits the first transmission file to the receiving terminal.

The receiving terminal stores the received first file into the storage device of the receiving terminal or transmits the first file to the multifunction apparatus 114 on the basis of the processing condition 603. The receiving terminal notifies the transmitting terminal that the receiving terminal has received the first file.

When the transmission of the first transmission file is completed, as shown in 901 in FIG. 9, the transmitting terminal requests the receiving terminal to allow the start of a job by a SOAP Create Job command (job creation request). The SOAP Create Job command includes attributes necessary for starting a job, such as, for example, a user name, a job name, a file name, a format of transmission file (for example, tiff or the like), the size of the second file to be transmitted, and the processing condition 603 associated with the second file. When there is a message that is a character string such as a comment associated with the second transmission file, the transmitting terminal transmits the message to the receiving terminal along with the SOAP Create Job command.

When the receiving terminal receives the SOAP Create Job command, the receiving terminal recognizes the attribute of the second file transmitted from the transmitting terminal. The receiving terminal checks the size of the second transmission file included in the SOAP Create Job command and the capacity of the memory or the storage device of the receiving terminal, and when the free space is sufficient, the receiving terminal transmits a SOAP Create Job Response command that allows the start of the job to the transmitting terminal (job creation response).

When the transmitting terminal receives the SOAP Create Job Response command, the transmitting terminal recognizes that the job creation request is allowed. When a session is established by the above communication, in 902, the transmitting terminal transfers the second transmission file to the receiving terminal.

The receiving terminal stores the received second file into the storage device of the receiving terminal or transmits the second file to the multifunction apparatus 114 on the basis of the processing condition 603. The receiving terminal notifies the transmitting terminal that the receiving terminal has received the second file.

When the transmission of the second file is finished, in other words, when the data transmission is completed, the connection used for the communication is closed in 903. First, the transmitting terminal transmits a FIN command that ends the data transmission to the receiving terminal. When the receiving terminal receives the FIN command, the receiving terminal responds to the transmitting terminal with an ACK command that acknowledges the end of the upstream connection. Subsequently, the receiving terminal transmits a FIN command to the transmitting terminal. When the transmitting terminal receives the FIN command, the transmitting terminal responds to the receiving terminal with an ACK command that acknowledges the end of the downstream connection. In this way, when the transmitting terminal and the receiving terminal send the FIN command to each other after the data transmission is finished and receive the ACK command for acknowledging the FIN command, the connection between the transmitting terminal and the receiving terminal is closed. Next, the transmitting terminal performs communication for closing the session of SIP connection (904). The processing for connecting and closing the communication is only an example of the embodiment, and it is not limited to this.

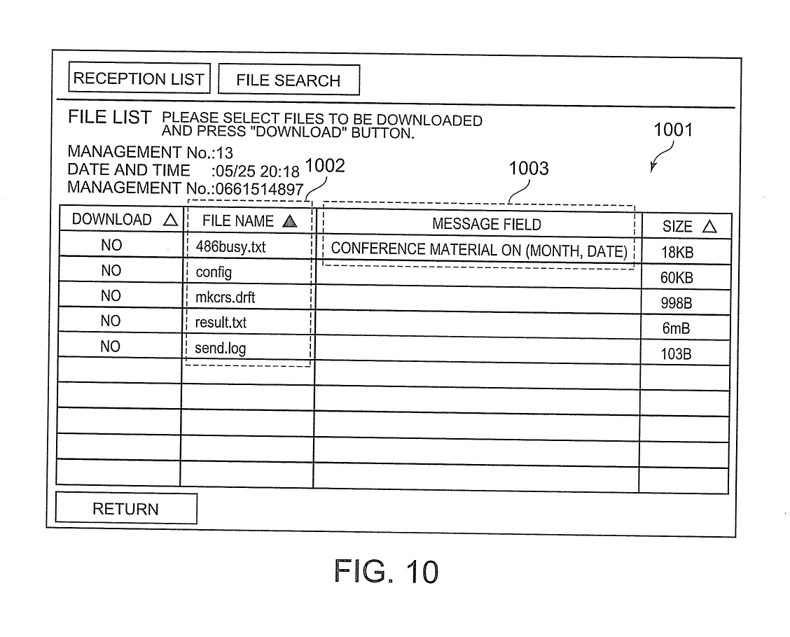

FIG. 10 is an example of a user interface screen in which a list of files received by the communication apparatus 122 that is the receiving terminal by the communication described above is displayed on the display unit of the user terminal 118 or the multifunction apparatus 114 by a Web browser function. The control unit 202 of the communication apparatus generates display data for displaying the user interface screen as shown in FIG. 10 on the display unit of the user terminal 118 or the multifunction apparatus 114. Reference numeral 1001 in FIG. 10 denotes a list of received files. The received files displayed in the list stored in the communication apparatus 122 can be downloaded to the, user terminal 118. The list 1001 includes an area 1002 in which file names of the received files are displayed and a message field 1003 in which messages that are character strings such as a comment associated with each received file are displayed.

According to the above-described embodiment, the transmitting terminal obtains a message of character string such as information to be transmitted in addition to registration of the file to be transmitted, and when the transmitting terminal transmits the file, the transmitting terminal transmits the obtained message to the receiving terminal. Then the receiving terminal generates a list including file names of the received files and messages of character string. In this way, a user can see information more than the file name in the message field 1003 displayed in the list of the receiving terminal, so that the user can correctly presume the content of the received file without opening the received file. Therefore, the user can easily determine a file which the user desires to print, transfer, or store into another storage device among the files stored in the receiving terminal.

Although, an example is described in which the processing for compressing the transmission files is performed after the transmission instruction is issued in FIG. 5 as an example, it is not limited to this. The processing from 506 to 508 in FIG. 5 may be performed before the transmission instruction is received. For example, an instruction for displaying a transmission confirmation screen is received before the transmission instruction is issued, and the compression processing may be performed after the instruction for displaying a transmission confirmation screen is received. Although, in the above-described embodiments, a case is described in which the communication apparatus is a device other than the multifunction apparatus (image forming device), it is not limited to this. For example, a main body that performs an operation of the communication apparatus is included in the multifunction apparatus, and thereby a device in which the communication apparatus and the multifunction apparatus are integrated together may be used.

A main body that performs an operation is a main body related to a computer, such as, for example, hardware, a complex body of hardware and software, software, and software in execution. Although main bodies that perform an operation are, for example, a process executed on a processor, a processor, an object, an execution file, a thread, a program, and a computer, they are not limited to these. For example, a multifunction apparatus, a processing device, and an application executed on these may be a main body that performs the operation. Processes and threads may implement a plurality of main bodies that performs the operation. The main body that performs the operation may be included in one document processing device, or the main bodies are distributed to a plurality of document processing devices.

Although, in the above-described embodiments, a case is described in which a function that implements the invention is previously stored inside the device, it is not limited to this, and the same function may be downloaded from a network to the device, or a recording medium storing the same function maybe installed in the device. The recording medium may have any form as long as the recording medium, such as a CD-ROM, can store a program and can be read by the device. The function obtained previously by the installation or download as described above may realize the function in cooperation with the OS (Operating System) and the like inside the device.

What is claimed is:

1. A communication apparatus comprising:
an interface for connecting with an external device and at least one communication terminal via a network;
a memory for storing at least one destination address of a communication terminal, at least one file to be transmitted, and a message registered for each file that is received from the external device via the interface; and
a controller for transmitting the file and the message registered for each file to the communication terminal of the destination address via the interface when the controller obtains a transmission instruction of the file via the interface.

2. The communication apparatus according to claim 1, wherein, when the controller receives, via the interface, the file and the message registered for each file from the communication terminal via the network, the controller stores the received file and the message into the memory and generates display data for displaying a list of file names of the received file and the message associated with the file on a display unit of the external device via the interface.

3. The communication apparatus according to claim 1, wherein the controller obtains processing information, which is set for each file, of processing performed by the communication terminal before the controller receives the transmission instruction, and transmits the processing information associated with the file to the communication terminal when the controller obtains the transmission instruction of the file via the interface.

4. The communication apparatus according to claim 1, wherein
the external device is an image forming device including a scanner, and
when the controller obtains the transmission instruction via the interface, the controller obtains the file of image data of an original document read by the image forming device via the scanner, and transmits the obtained file to the communication terminal along with the message.

5. The communication apparatus according to claim 1, wherein, when the controller is instructed to compress a plurality of files to be transmitted into a single file and transmit the file, the controller determines whether each of the plurality of files has the message associated with the file, and when the controller determines that each of the plurality of files has the message, the controller compresses the plurality of files into a single file, associates a message which is associated with only one file among the plurality of files before compression with the compressed file, and transmits the message to the communication terminal.

6. The communication apparatus according to claim 1, wherein when the communication apparatus obtains a transmission instruction of the files via the interface, the communication apparatus establishes a connection with the communication terminal via the interface and transmits the messages to the communication terminal before transmitting the files.

7. A communication method for transmitting a file to a destination terminal via a network, the communication method comprising:
registering the destination terminal to which the file is transmitted;
obtaining the file to be transmitted to the destination terminal;
providing a message associated with the file to the file; and
transmitting the file to the destination terminal with the message.

8. The communication method according to claim 7, further comprising receiving the file and the message provided to the file via the network and generating display data for displaying a list of file name of the received file and the message associated with the file.

9. The communication method according to claim 7, further comprising, in relation to the file, transmitting an attribute necessary for a job performed at the destination terminal.

10. The communication method according to claim 6, further comprising generating the file including image data by scanning an original document and transmitting the file and the message to the destination terminal.

11. The communication method according to claim 6, further comprising, when there is a plurality of the obtained files, compressing the files into a single file in a predetermined format.

12. The communication method according to claim 11, further comprising, when compressing the files into a single file, associating a message related to one file among a plurality of the files before compression with the compressed file, and transmitting the message to the communication terminal.

13. The communication method according to claim 11, further comprising:
defining the file name of the file stored earliest as a transmission file among the plurality of files as a file name of the compressed file; and
associating a message related to the file stored earliest as the transmission file among a plurality of the files before compression with the compressed file and transmitting the message to the communication terminal.

14. The communication method according to claim 11, further comprising, when no message is provided to the file stored earliest as the transmission file among a plurality of the files before compression, transmitting the compressed file without providing a message to the compressed file.

15. The communication method according to claim 9, further comprising, before transmitting the file and when transmitting an attribute necessary for a job, transmitting the message to the communication terminal.

16. The communication method according to claim 10, further comprising:
inputting a processing condition including print processing and storage processing of the file to be transmitted at the destination terminal,
determining whether the file to be transmitted is an encrypted file, and
when the file is determined to be an encrypted file, even if the inputted processing condition is the print processing, changing the processing condition to the storage processing and transmitting the processing condition to the destination terminal.

17. A multifunction apparatus that scans an original document and transmits the scanned original document to a destination terminal, the multifunction apparatus comprising:
a registering unit for registering the destination terminal to which the file is transmitted;
an obtaining unit for obtaining the file to be transmitted to the destination terminal;
a providing unit for providing a message associated with the obtained file to the file; and
a transmitting unit for transmitting the file to the destination terminal along with the provided message.

18. The multifunction apparatus according to claim 17, further comprising a compressing unit for, when there is a plurality of the obtained files, compressing the files into a single file in a predetermined format,
wherein, when the compressing unit compresses a plurality of the files into the single file, the multifunction apparatus associates a message related to one file among a plurality of the files before compression with the compressed file and transmits the message to the destination terminal.

19. The multifunction apparatus according to claim 18, wherein the multifunction apparatus defines a file name of the compressed file as the file name of the file stored earliest as a transmission file among the plurality of files, associates a message related to the file stored earliest as a transmission file among the plurality of files before compression with the compressed file, and transmits the message to the destination terminal.

20. The multifunction apparatus according to claim 19, wherein, when no message is provided to the file stored earliest as a transmission file among a plurality of files before compression, the multifunction apparatus transmits the compressed file without providing a message to the compressed file.
